(19) United States
(12) Patent Application Publication
(10) Pub. No.: US 2004/0021134 A1
(43) Pub. Date: Feb. 5, 2004

(54) Electro-rheological fluid comprising dried water-soluble starch and additive

(75) Inventors: Moon-Suk Suh, Daejeon (KR); Min-Jae Shin, Daejeon (KR); Kyo-Jun Choi, Daejeon (KR); In-Sik Han, Daejeon (KR); Sun-Kyu Jeong, Daejeon (KR); Seung-Bok Choi, Incheon (KR); Ho-Guen Lee, Incheon (KR)

Correspondence Address: SCULLY SCOTT MURPHY & PRESSER, PC, 400 GARDEN CITY PLAZA, GARDEN CITY, NY, 11530

(73) Assignee: Agency for Defense Development, Daejeon (KR)

(21) Appl. No.: 10/603,906

(22) Filed: Jun. 25, 2003

(30) Foreign Application Priority Data
Jul. 31, 2002 (KR) 10-2002-0045361

(51) Int. Cl. H01B 3/24

(52) U.S. Cl. 252/570

(57) ABSTRACT

Disclosed is an ER fluid comprising a water-soluble starch as a conductive particle and an additive to improve flow properties and to prevent precipitation of the ER fluid. The ER fluid can be widely applied to a variable attenuator which is able to control a suspension, a vibration damper and an engine mount, to a power unit such as a break and a clutch, and to various industrial fields such as an automobile and aviation industries.

### BACKGROUND OF THE INVENTION

1. Field of the Invention

The present invention relates to an electro-rheological fluid in which a water-soluble starch and additive are dispersed into a non-conductive solvent.

2. Description of the Background Art

Generally, electro-rheological (hereinafter, referred to as “ER”) fluid refers to a fluid whose mechanical properties are variable depending on an intensity of applied electric field. It is basically a colloidal fluid comprising highly conductive particles and a non-conductive solvent, in which the highly conductive particles are dispersed into the non-conductive solvent. When an electric field is applied, yield stress and viscosity of ER fluid are increased, and such response to the applied electric field is very quick and reversible. Such effect is known as an “ER effect”.

FIGS. 1a and 1b show an outlined principle in which ER fluid exhibits the ER effect against the applied electric field. As shown in FIG. 1a, when no electric field is applied, the ER fluid 101 exhibits Newtonian fluid properties in which conductive particles 103 flow together with a non-conductive solvent 102 within an electrode 104. However, as shown in FIG. 1b, the ER fluid 101 displays a Bingham behavior in which the yield stress is increased as an external electric field is applied.

The first ER fluid, developed at the end of the 19th century, consisted of liquids only, but it failed to show satisfactory performances (Duff, A. W., Physical Review, Vol. 4, No. 1, 23 (1896)).

Later, a solid dispersion system proposed by Winslow at first have provided a considerable progress in the field of ER fluid (Winslow, W. H., J. of Applied Physics, Vol. 20, 1137 (1949)). Since then, researches have been conducted into a system in which conductive particles are dispersed into a nonconductive solvent.

As the conductive particle, silica gel, water-soluble starch or a semiconductor material has been used.

It has been known that ER fluid comprising a water-soluble starch, which is an aqueous material, as a conductive particle displays ER effect only if it contains at least 5 wt % of water. That is, if the water content of ER fluid comprising the water-soluble starch is less than 5 wt %, it cannot be used as an ER fluid because its reversibility rapidly degrades. However, the water contained in ER fluid can cause corrosion of a device, restrict its operation temperature and incur higher power consumption.

Accordingly, there have been proposed an ER fluid which comprises a water-soluble starch as a conductive particle and less than 5 w % of water and shows good ER effect. However, when such ER fluid is actually applied to apparatus having narrow bent tubes, precipitation is occurred to result in fluidity lowering. However, in this case, inner parts of the apparatuses may be clogged by the precipitated particles, and therefore, it is difficult to achieve desired performances.

### SUMMARY OF THE INVENTION

Therefore, an object of the present invention is to solve problems of the conventional ER fluid and to provide an ER fluid, comprising a dried water-soluble starch as a conductive particle and exhibiting an excellent ER effect and flow properties.

The foregoing and other objects, features, aspects and advantages of the present invention will become more apparent from the following detailed description of the present invention when taken in conjunction with the accompanying drawings.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIGS. 1a and 1b are microscopic schematic views showing that an ER effect is induced by an applied electric field;

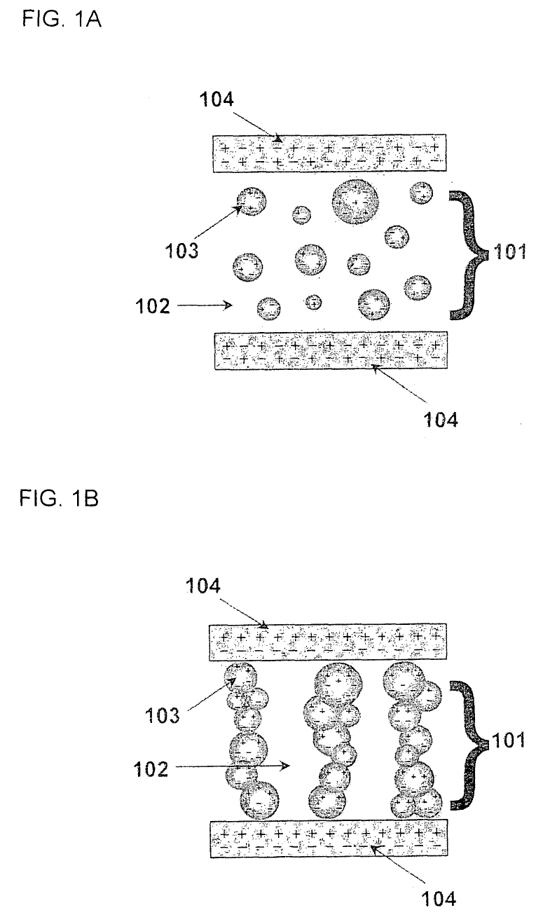

FIG. 2 is a flow chart illustrating a preparation method of an ER fluid according to the present invention;

FIGS. 3a and 3b are microscopic photographs in which ER fluid according to the present invention exhibits ER effect when an electric field is applied thereto;

FIGS. 4a and 4b are graphs showing experimental results of Bingham properties of ER fluid comprising 35 wt % of water-soluble starch and 0.2 wt % of NP20™;

FIGS. 5a and 5b are graphs showing experimental results of Bingham properties of ER fluid comprising 35 wt % of water-soluble starch and 0.2 wt % of SPAN80™;

FIGS. 6a and 6b are graphs showing experimental results of Bingham properties of ER fluid comprising 35 wt % of water-soluble starch and 0.2 wt % of BRIJ30™;

FIGS. 7a and 7b are graphs showing experimental results of Bingham properties of ER fluid comprising 35 wt % of water-soluble starch, 0.2 wt % of NP20™ and 0.2 wt % of SPAN80™;

FIGS. 8a and 8b are graphs showing experimental results of Bingham properties of ER fluid comprising 35 wt % of water-soluble starch, 0.2 wt % of SPAN80™ and 0.2 wt % of BRIJ30™;

FIGS. 9a and 9b are graphs showing experimental results of Bingham properties of ER fluid comprising 35 wt % of water-soluble starch, 0.2 wt % of NP20™, 0.2 wt % of SPAN80™ and 0.2 wt % of BRIJ30™;

FIGS. 10a and 10b are graphs showing experimental results of Bingham properties of ER fluid comprising 35 wt % of water-soluble starch and 0.2 wt % of SPAN80™ relative to temperature variations in shear mode; and

FIGS. 11a and 11b are graphs showing experimental results of Bingham properties of ER fluid comprising 35 wt % of water-soluble starch and 0.2 wt % of BRIJ30™ relative to temperature variations in flow mode.

### DETAILED DESCRIPTION OF THE INVENTION

Reference will now be made in detail to the preferred embodiments of the present invention, examples of which are illustrated in the accompanying drawings.

To achieve the object of the present invention, there is provided an ER fluid, comprising a dried water-soluble starch as a conductive particle, an additive to improve flow properties of the fluid and to reduce precipitation of particles, and less than 5 wt % of water. Therefore, the ER fluid according to the present invention comprises a water-soluble starch, less than 5 wt % of water to the total weight of the fluid, an additive and a non-conductive solvent. Hereinafter, the present invention will be described in detail.

The content of the water-soluble starch in the ER fluid of the present invention is 5-70 wt %, preferably 20-60 wt %, and most preferably 30-60 wt % of the total weight of the fluid. When the ratio of the particles is less than 5 wt %, the ER effect is too low. In the mean time, as the content of the water-soluble starch is increased, the properties of ER fluid is improved. However, it is preferred that the content of the water-soluble starch is not more than 70 wt %, since when the weight ratio of the particles is too high, current density is too high so as to possible to cause a short-circuit. In addition, if the viscosity of fluid becomes too high when no electric field is applied, a lowest damping force, that is, a mechanical properties relating to the viscosity is too high when ER fluid is actually applied to apparatuses. It is preferable that the water-soluble starch particles have a diameter less than 10 μm.

In the ER fluid of the present invention, water content is less than 5 wt %, preferably less than 3 wt %, and most preferably less than 1 wt % (excluding 0 wt %), and the content of additive is less than 1 wt %, and preferably less than 0.2 wt % (excluding 0 wt %).

A material which can be used as a non-conductive solvent is not limited. Any material can be used as a non-conductive solvent as long as it does not have an adverse influence on the other components of ER fluid, that is, water-soluble starch and other components, has an adequate stability within a normal operation temperature range, and has a low viscosity when no electric field is applied so that it can contain a large enough amount of conductive particles. Examples of the non-conductive solvent include silicon oil, transformer oil, transformer insulating fluid, mineral oil, olive oil or mixtures thereof, but not limited thereto.

The ER fluid of the present invention may comprise other components as long as they do not have an adverse influence on properties of the non-conductive solvent and water-soluble starch. Examples of such components include an aromatic hydroxy compound as disclosed in U.S. Pat. No. 5,683,620 and another conductive particle including silica gel.

The ER fluid of the present invention is characterized in that it comprises an additive which does not have an adverse influence on the properties of other components contained in ER fluid, and is capable of exhibiting an appropriate performance at a normal operation temperature range, improving flow properties of the fluid and preventing precipitation of particles. Such an additive may be a surfactant, and examples include SPAN80™, BRIJ30™, NP20™ and mixtures thereof.

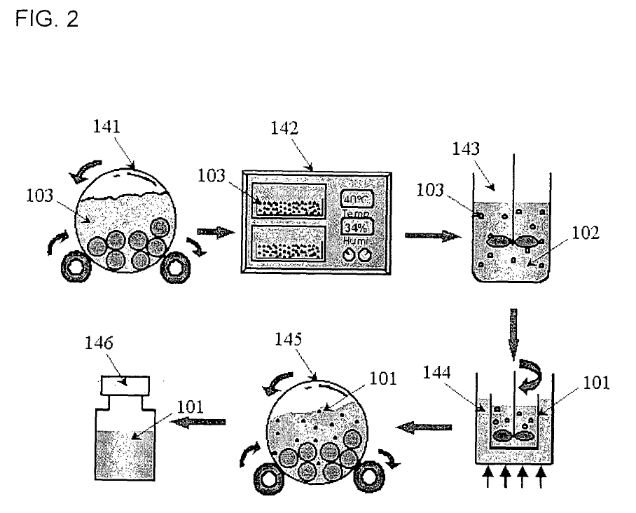

Hereinafter, a preparation method of the ER fluid of the present invention will be described. FIG. 2 illustrates a preferable preparation method of the ER fluid of the present invention.

The ER fluid 101 of the present invention is prepared by grinding and drying a water-soluble starch 103, mixing the dried ground water-soluble starch 103 with a mixture 102 of a non-conductive solvent and additive, and heating in a bath 144. In more detail, the preparation method of the ER fluid of the present invention is as follows:

1) grinding water-soluble starch particles 103 in a grinder 141 so as the water-soluble starch particles to have less than 10 μm in size;

2) drying the ground water-soluble starch particles 103 in a thermohygrostatic chamber 142 at a temperature of 35-45° C. and relative humidity of 0-50%;

3) mixing a non-conductive solvent with an additive at a predetermined weight ratio, and sufficiently stirring the resulting mixture;

4) mixing the dried ground water-soluble starch particles 103 obtained in step 2) with the mixture 102 obtained in step 3) at a predetermined weight ratio in a receptacle;

5) heating the fluid 101 obtained in step 4) at 80-150° C. in an oil bath 144;

6) grinding the heated ER fluid 101 in a grinder 145 so as to mix uniformly; and

7) storing the prepared ER fluid in a bottle 146.

Heating in step 5) is to remove a small amount of water included in the fluid. Therefore, it is preferable that heating temperature is higher than 100° C.

Water content of the ER fluid prepared by the above method is maintained at less than 5 wt %, preferably less than 3 wt %, and most preferably less than 1 wt % (excluding 0 wt %). Water content range in the ER fluid can be adjusted by controlling the temperature range and relative humidity of the thermohygrostatic chamber 142 in step 2).

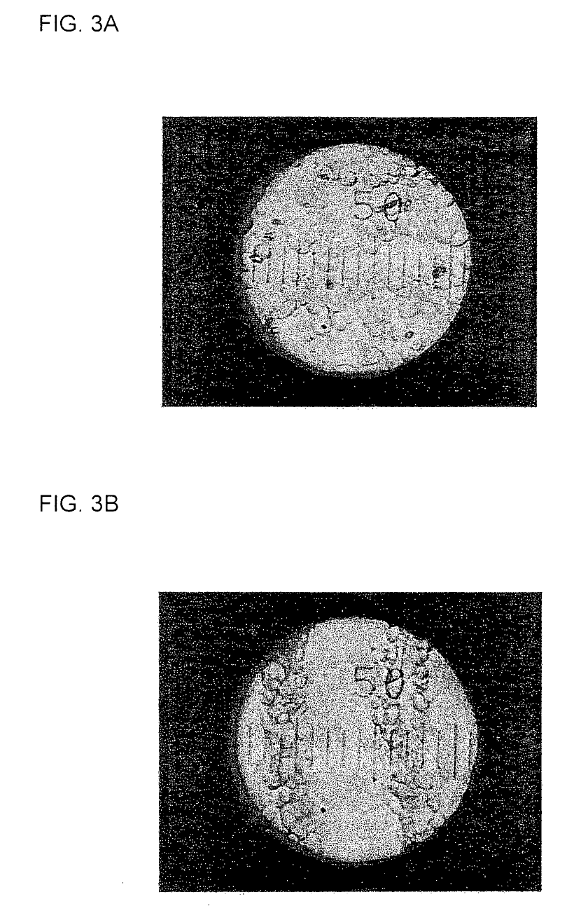

FIGS. 3a and 3b are microscopic photographs showing that the ER fluid of the present invention exhibits an ER effect when the electric field is applied. As shown in FIG. 3a, the water-soluble starch particles dispersed in the non-conductive solvent show properties of a Newtonian fluid when no electric field is applied. However, when electric field is applied, the water-soluble starch particles form a chain structure in the direction of the electric field vertical to two electrodes that are in parallel, and accordingly, the yield stress is increased, thereby to exhibit a Bingham behavior (FIG. 3b). These microscopic photographs were taken by applying the electric field of 3 kV/nm between two parallel electrodes spaced apart by 1 mm.

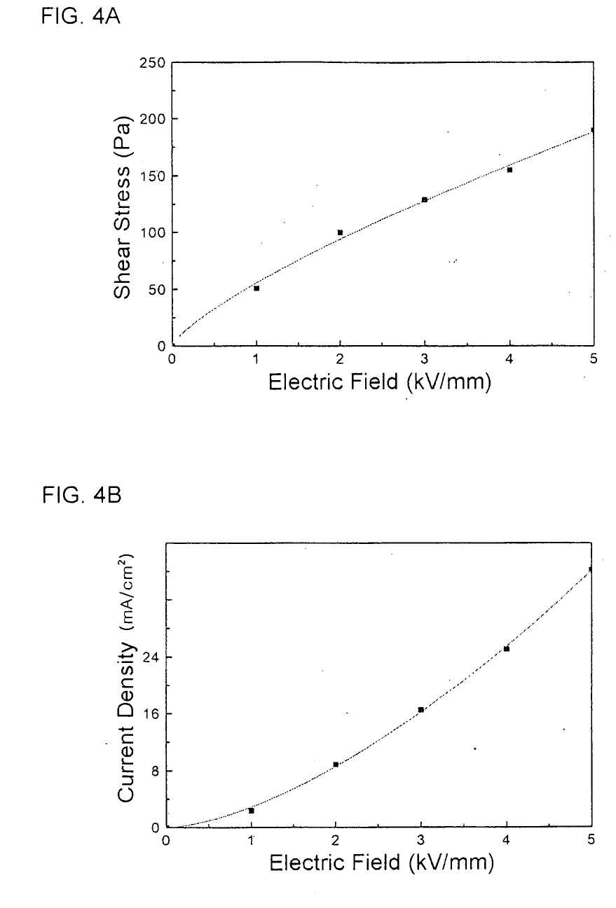

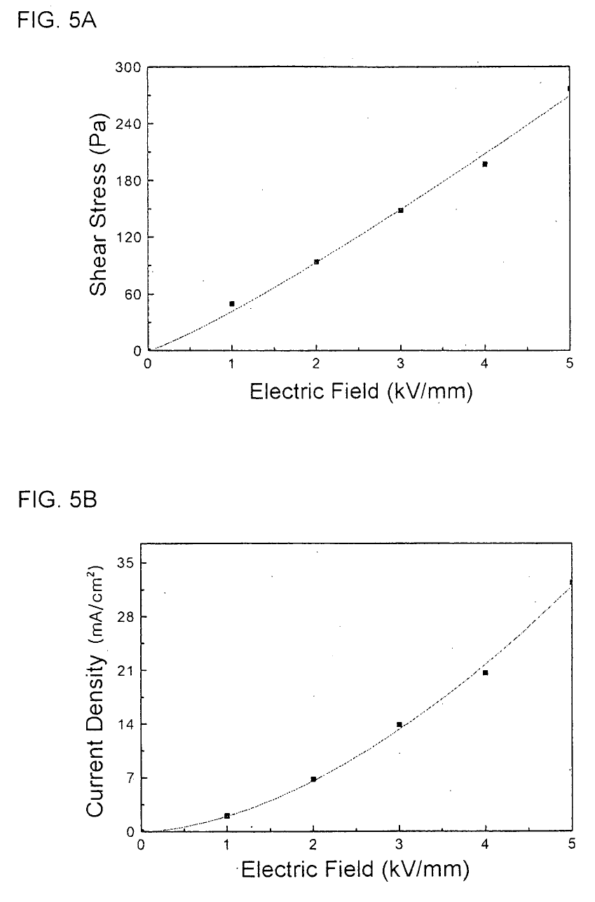

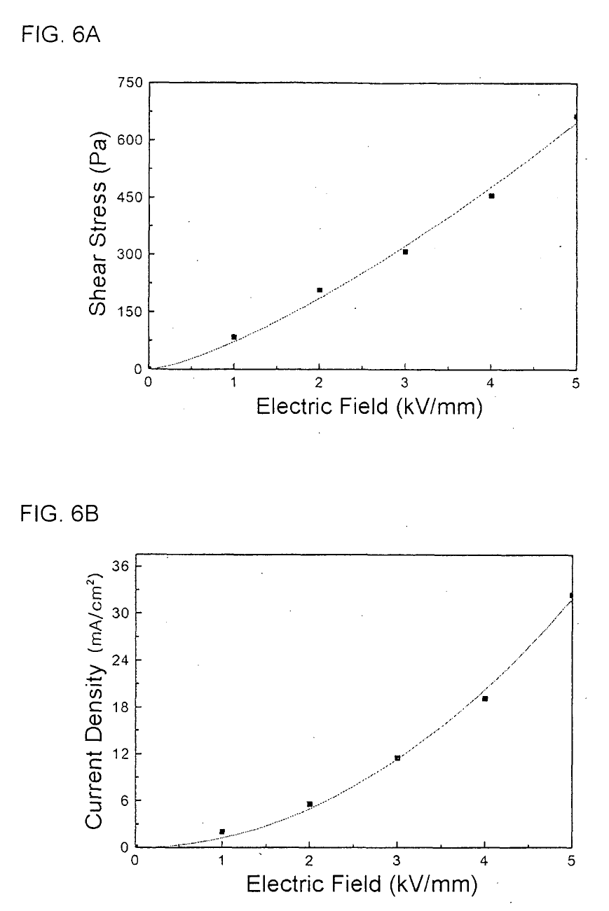

In order to determine the influence of the additive added into ER fluid, the variations of the properties of ER fluid depending on the applied electric field were observed at room temperature, and FIGS. 4-11 show the results.

FIGS. 4-6 show experimental results of Bingham properties of three kinds of ER fluids prepared by adding 0.2 wt % of NP20™, SPAN80™ and BRIJ30™, respectively, into ER fluid comprising water-soluble starch. In each sample showing the results of FIGS. 4-6, ratio of the water-soluble starch to the non-conductive solvent is 35 wt %. Starch particles were dried for 210 seconds in a microwave before being dispersed in the solvent, and the obtained respective ER fluids were boiled for 15 minutes at a high temperature. It was discovered that the yield stress exhibited the largest value when BRIJ30™ was added.

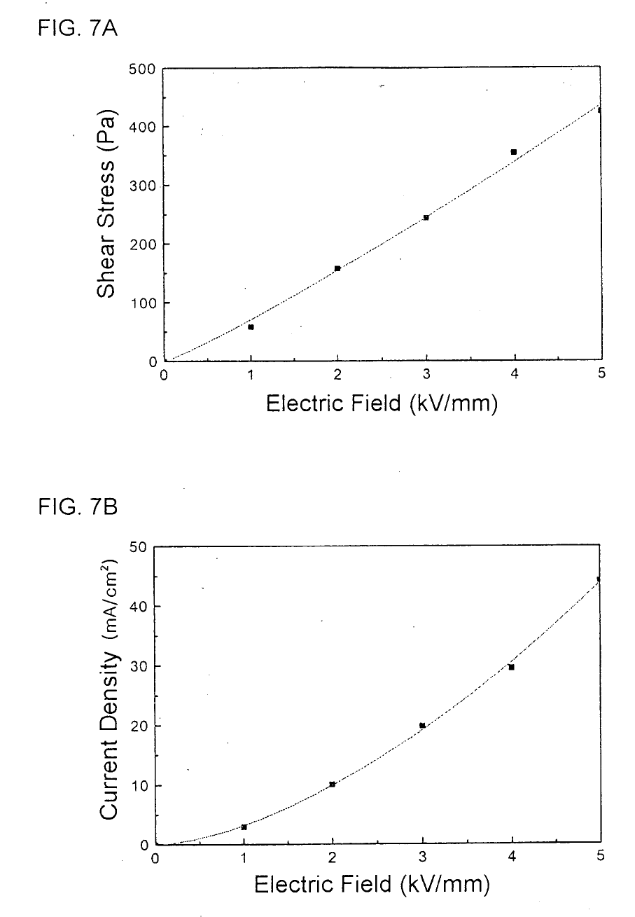

FIG. 7 shows the experimental result of Bingham properties of ER fluid prepared by adding 0.2 wt % of NP20™ and 0.2 wt % of SPAN80™ into ER fluid comprising the water-soluble starch, which contains 0.4 wt % of additives.

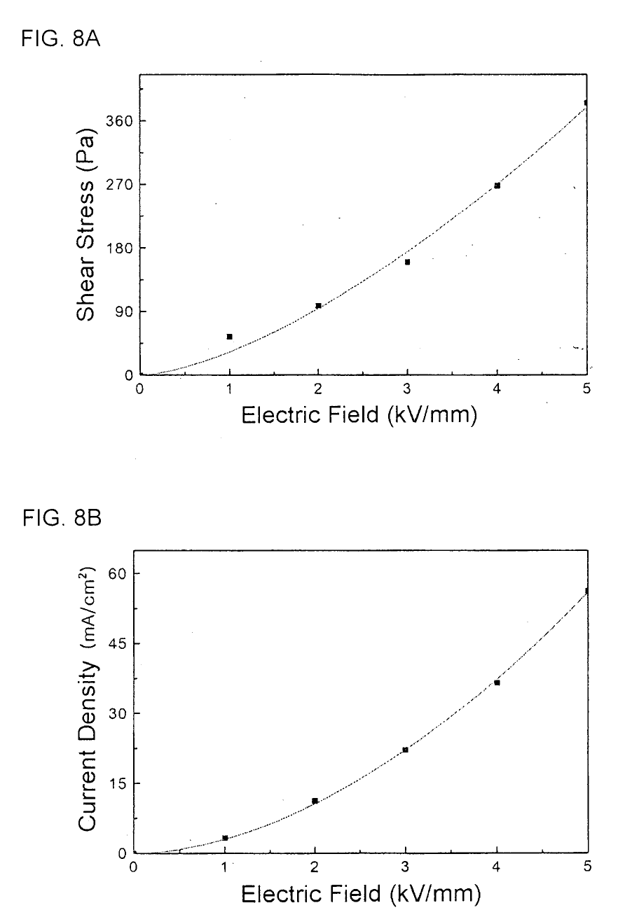

FIG. 8 shows the experimental result of Bingham properties of ER fluid prepared by adding 0.2 wt % of BRIJ30™ and 0.2 wt % of SPAN80™ into ER fluid comprising the water-soluble starch, which contains 0.4 wt % of additives.

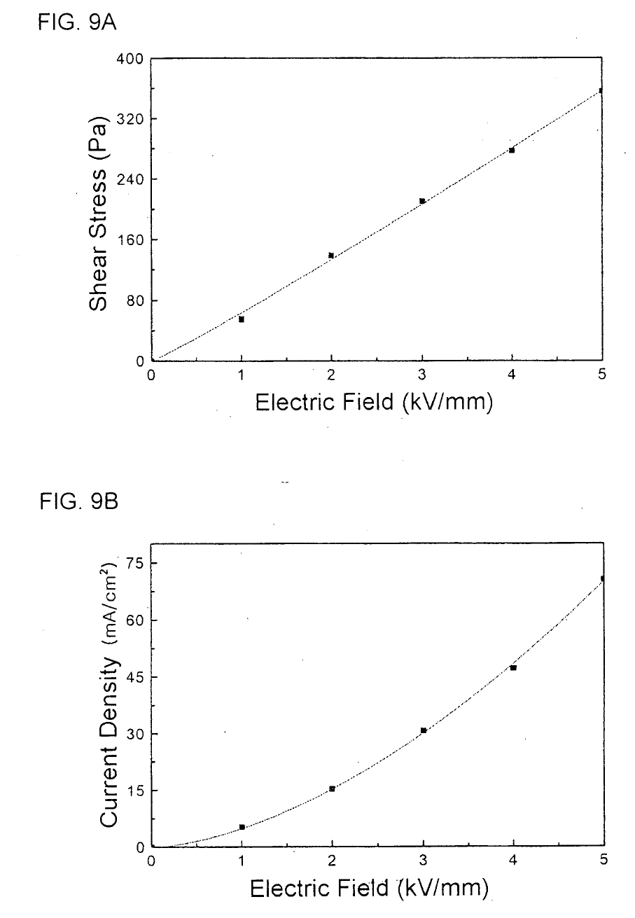

FIG. 9 shows the experimental result of Bingham properties of ER fluid prepared by adding 0.2 wt % of BRIJ30™, 0.2 wt % of SPAN80™ and 0.2 wt % of NP20™ into ER fluid comprising the water-soluble starch, which contains 0.6 wt % of additives.

In the each sample exhibiting the results as shown in FIGS. 7-9, weight ratio of the water-soluble starch to the non-conductive solvent is 35%. The water-soluble starch particles were dried for 210 seconds in the microwave before being dispersed in the solvent, and the obtained respective ER fluids were boiled for 15 minutes at a high temperature. Comparing FIGS. 7-9 with each other, it is discovered that the performance of the fluid is lowered as the amount of additives increase.

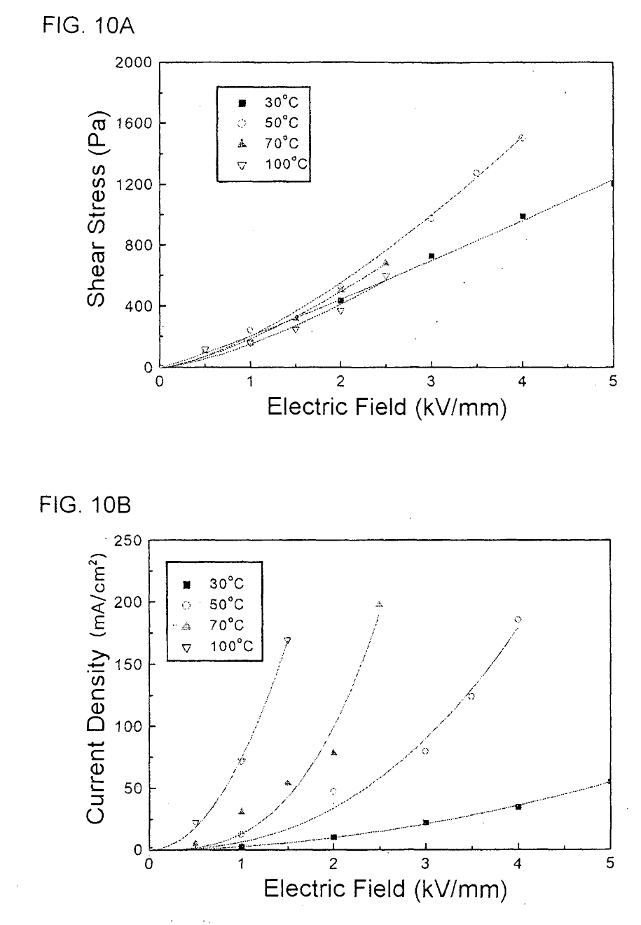

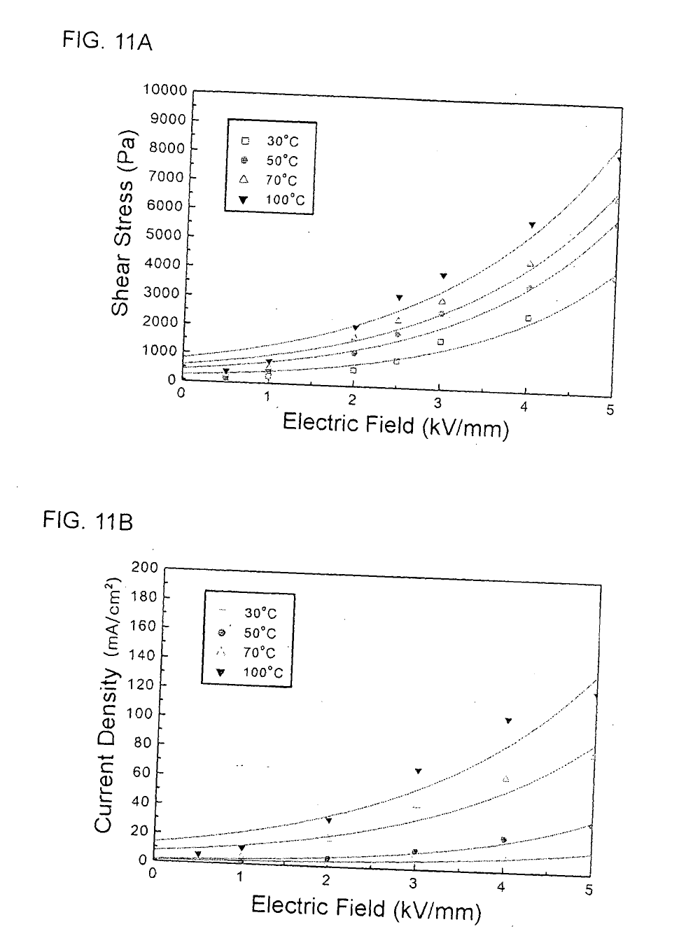

From the experimental results as above, it was discovered that BRIJ30™ is the best additive. Therefore, an ER fluid comprising 0.2 wt % of BRIJ30™ was prepared and tested Bingham properties with respect to the temperature in shear and flow modes, respectively. FIGS. 10 and 11 show the results.

FIG. 10 shows experimental result of Bingham properties of ER fluid according to temperature change in shear mode. The BRIJ30™ does not cause increase of viscosity of ER fluid unlike other surfactants, but rather improves flow properties. An ER fluid comprising 0.2 wt % of surfactant BRIJ30™ and 45 wt % of starch particles was prepared using a solvent having a viscosity of 30 cS, and tested Bingham properties with respect to temperatures. In this ER fluid, when the electric field of 5 kV/mm is applied at room temperature, it shows yield stress of 1200 Pa with a current density of 54 μA/cm². Where the temperature is raised to 50° C., the yield stress is 1,500 Pa under the electric field of 4 kV/mm. However, at this time current density is 200 μA/cm², which exceeds the capacity of a high voltage supply. Electric field of about 3.5 kV/mm can be applied at the current density of about 100 μA/cm² which can be supplied with the high voltage supply. At this time, the yield stress is about 1,300 Pa. However, the current density exceeds its upper limit at the yield stress of 550 Pa where the temperature is 70° C. and at the yield stress of 250 Ps where the temperature is 100° C. Therefore, it is difficult to expect achieving better performances. That is, it is expected that the ER fluid of the present invention can show satisfactory performances when the test is performed at upper limit temperature of around 50° C.

FIG. 11 shows experimental results of Bingham properties of ER fluid according to temperature with a flow mode type electric viscometer. It shows that even if the intensity of the current density is limited to 100 μA/cm², the yield stress exceeds 5,000 Pa at all temperature ranges. Therefore, it is expected to show superior performance reproducibility when being applied to apparatuses.

The water-soluble starch used in the present invention is a conductive substance which can be selectively dissolved in a polar solvent. The water-soluble starch particles are dispersed into a non-conductive solvent such as silicon oil, to generate an electrical polarization in which the conductive particles are polarized to cause ER effect. In the polarization, there are electronic, ionic and molecular polarizations, and these three kinds of polarizations generally occur together rather than being separately acted. Likewise, in case of the water-soluble starch particles, those polarization phenomena occur together so as to cause the ER effect.

The properties of the ER fluid according to the present invention was determined with a commercially available rheometer. However, the yield stress and the current density which are principal properties of ER fluid were determined with an apparatus having an additional function to change electric field and temperature besides the basic functions of a rheometer.

As described above, the present invention solves disadvantages of the conventional ER fluid which can not be applied to actual apparatuses since an ER effect is not shown or a current density is too high at high temperature. It was discovered that the ER fluid according to the present invention can exhibit ER effect at any temperature ranges.

In addition, phenomena of precipitation and lacking flow properties, which have been problems of the conventional ER fluids, are improved in the present invention. A response time, which is an important factor when the ER fluid is applied to apparatuses to control, is very short. Power consumption is very small since the current required to show ER effect is small. ER fluid of the present invention shows stable Bingham behavior to electric field variations.

Accordingly, the ER fluid of the present invention can be widely applied to a variable attenuator which is able to control a suspension, a vibration damper and an engine mount, to a power unit such as a break and a clutch, and to various industrial fields such as an automobile and aviation industries.

As the present invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims, and therefore all changes and modifications that fall within the metes and bounds of the claims, or equivalence of such metes and bounds are therefore intended to be embraced by the appended claims.

What is claimed is:

1. An electro-rheological fluid, comprising a water-soluble starch, less than 5 wt % (excluding 0 wt %) of water to total weight of the electro-rheological fluid, an additive to improve flow properties of the fluid and to prevent precipitation of particles in the fluid, and a non-conductive solvent.

2. The electro-rheological fluid according to claim 1, wherein water content is less than 3 wt % (excluding 0 wt %).

3. The electro-rheological fluid according to claim 1, wherein water content is less than 1 wt % (excluding 0 wt %).

4. The electro-rheological fluid according to claim 1, wherein the non-conductive solvent is selected from the group consisting of silicon oil, transformer oil, transformer insulating fluid, mineral oil, olive oil and mixtures thereof.

5. The electro-rheological fluid according to claim 2, wherein the non-conductive solvent is selected from the group consisting of silicon oil, transformer oil, transformer insulating fluid, mineral oil, olive oil and mixtures thereof.

6. The electro-rheological fluid according to claim 3, wherein the non-conductive solvent is selected from the group consisting of silicon oil, transformer oil, transformer insulating fluid, mineral oil, olive oil and mixtures thereof.

7. The electro-rheological fluid according to claim 1, wherein the content of the water-soluble starch is 5-70 wt % of total weight of the electro-rheological fluid.

8. The electro-rheological fluid according to claim 2, wherein the content of the water-soluble starch is 5-70 wt % of the total weight of the electro-rheological fluid.

9. The electro-rheological fluid according to claim 3, wherein the content of the water-soluble starch is 5-70 wt % of the total weight of the electro-rheological fluid.

10. The electro-rheological fluid according to claim 1, wherein the water-soluble starch is dried ground particles of less than 10 μm in size.

11. The electro-rheological fluid according to claim 2, wherein the water-soluble starch is dried ground particles of less than 10 μm in size.

12. The electro-rheological fluid according to claim 3, wherein the water-soluble starch is dried ground particles of less than 10 μm in size.

13. The electro-rheological fluid according to claim 10, prepared by an additional heating process.

14. The electro-rheological fluid according to claim 1, wherein the additive is a surfactant in an amount less than 1 wt % (excluding 0 wt %) of total weight of the electro-rheological fluid.

15. A preparation method of an electro-rheological fluid, comprising the steps of:
1) grinding water-soluble starch in a grinder so as to have a size less than 10 μm;
2) drying the water-soluble starch particles obtained in step 1) in a thermohygrostatic chamber at a temperature of 35-45° C. and relative humidity of 30-50%;
3) mixing a non-conductive solvent and an additive;
4) mixing the dried water-soluble starch particles obtained in step 2) with the mixture of the non-conductive solvent and additive obtained in step 3) such that the amount of the dried water-soluble starch particles is 5-70 wt % of total weight of the electro-rheological fluid;
5) boiling the fluid obtained in step 4) at 80-150° C. in an oil bath; and
6) grinding the obtained fluid in a grinder so as to uniformly mix particles contained in the fluid.
